(19) United States
(12) Patent Application Publication
(10) Pub. No.: US 2021/0263532 A1
(43) Pub. Date: Aug. 26, 2021

(54) TELEPRESENCE SESSION INITIATION LOCATIONS

(71) Applicant: Hewlett-Packard Development Company, L.P., Spring, TX (US)

(72) Inventors: William J. Allen, Corvallis, OR (US); David Murphy, Palo Alto, CA (US)

(73) Assignee: Hewlett-Packard Development Company, L.P., Spring, TX (US)

(21) Appl. No.: 17/265,556

(22) PCT Filed: Nov. 16, 2018
(86) PCT No.: PCT/US2018/061473

§ 371 Date: Feb. 3, 2021

(51) Int. Cl. G05D 1/02; H04W 4/029; H04N 7/14; G01S 19/01; G01C 21/20

(52) U.S. Cl. CPC G05D 1/0278; H04W 4/029; G05D 2201/0211; G01S 19/01; G01C 21/206; H04N 7/147

(57) ABSTRACT

In example implementations, an apparatus is provided. The apparatus includes a communication interface, a memory, a moving mechanism, and a processor. The communication interface is to receive a request to initiate a telepresence session. The memory is to store a location policy. The moving mechanism is to move the apparatus to a selected telepresence location to initiate the telepresence session based on the location policy. The processor is communicatively coupled to the communication interface, the memory and the moving mechanism. The processor is to determine the selected telepresence location to initiate the telepresence session in response to the request before the telepresence session is initiated.

### BACKGROUND

Robots are becoming more ubiquitous to help perform various different activities and functions. Robots can be used to help improve manufacturing capability, serve as an assistant to improve daily efficiency, and the like. Robots can vary from simply automated machines in a manufacturing assembly line, to more life-like machines that can mimic human movements and activities.

### BRIEF DESCRIPTION OF THE DRAWINGS

FIG. 1 is a block diagram of an example system of the present disclosure;

FIG. 2 is a block diagram of an example apparatus to initiate a telepresence session of the present disclosure;

FIG. 3 is a block diagram of an example operation of the apparatus based on a location policy of the present disclosure;

FIG. 4 is a flow chart of an example method for initiating a telepresence session the present disclosure; and

FIG. 5 is a block diagram of an example non-transitory computer readable storage medium storing instructions executed by a processor to initiate a telepresence session of the present disclosure.

### DETAILED DESCRIPTION

Examples described herein provide an apparatus and method to initiate a telepresence session based on a selected telepresence location. As discussed above, robots can be used to assist in a variety of different activities and functions. In one instance, robots can be used to communicate with other individuals. The robots can serve as a representation of a person in a particular location, while the person is remotely located from a user located with the robot.

In some instances, when a telepresence session is initiated on a robot the robot may activate in an undesirable location. For example, when the robot is activated to initiate the telepresence session the robot may be in a restricted conference room. In another example, the robot may be activated in a room where employees may be having a conversation about sensitive material. In another example, the robot may be at a user's home. The robot may be activated while the user is unpresentable or busy.

Examples of the present disclosure provide a location policy for the robot. The location policy may store preferences of a user or a corporation that may provide an optimized location to initiate telepresence sessions with the robot. For example, before initiating the telepresence session, the robot may be moved to a selected telepresence location as defined by the location policy. In addition, the robot may be positioned or posed as defined by the location policy to initiate the telepresence session with a user. As a result, the location policy may ensure that the robot does not accidently activate in a restricted area or an undesirable location.

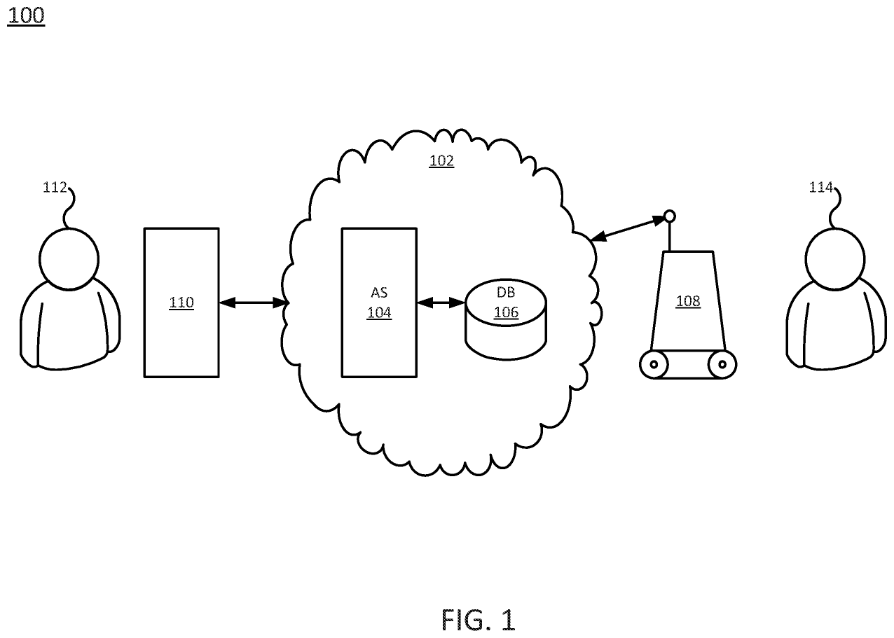

FIG. 1 illustrates an example a system 100 of the present disclosure. In one example, the system 100 may include a communication network 102. The communication network 102 may be an Internet protocol (IP) network. The communication network 102 may include an application server (AS) 104 and a database (DB) 106. The AS 104 may be a computing system that may execute various instructions to establish communication sessions across the communication network 102. The DB 106 may store information used by the AS 104 to establish the communication session and the instructions executed by the AS 104.

It should be noted that the communication network 102 has been simplified for ease of explanation. The communication network 102 may include additional network elements that are not shown (e.g., a gateway, border elements, firewalls, additional access networks, and the like).

In one example, a caller 112 may use an endpoint device 110 to establish a communication session with a recipient 114 via a robot 108. The communication session may be a telepresence session. For example, the telepresence session may include video and audio. In addition, the robot 108 may be used to mimic movements of the caller 112 at a location of the recipient 114 as if the caller 112 were at the location of the recipient.

In one example, the endpoint device 110 may be any type of endpoint device 110 that provides video and/or audio. For example, the endpoint device 110 may be a desktop computer, a laptop computer, a tablet computer, a mobile phone, and the like. In one example, the endpoint device 110 may also be a robot that is similar to the robot 108.

In one example, the robot 108 may have a display that provides video and audio for the telepresence session. In one example, the robot may also include limbs (e.g., arms, hands, feet, a torso, and the like). The robot 108 may be mobilized and moved to a desired location, as discussed in further detail below, before the communication session is activated. The robot 108 may be moved into a selected telepresence location where the recipient 114 would like to initiate the telepresence session or where the robot 108 is allowed to initiate the telepresence session.

In addition, the robot 108 may be set at a particular pose and posture at the location. The pose may include the x, y, and z coordinates of the robot 108 and in some instances, the roll, the pitch, and the yaw. The posture may include the position of movable limbs (e.g., arms folded, hands to the side, the torso bent forward, legs in a neutral stance, and the like).

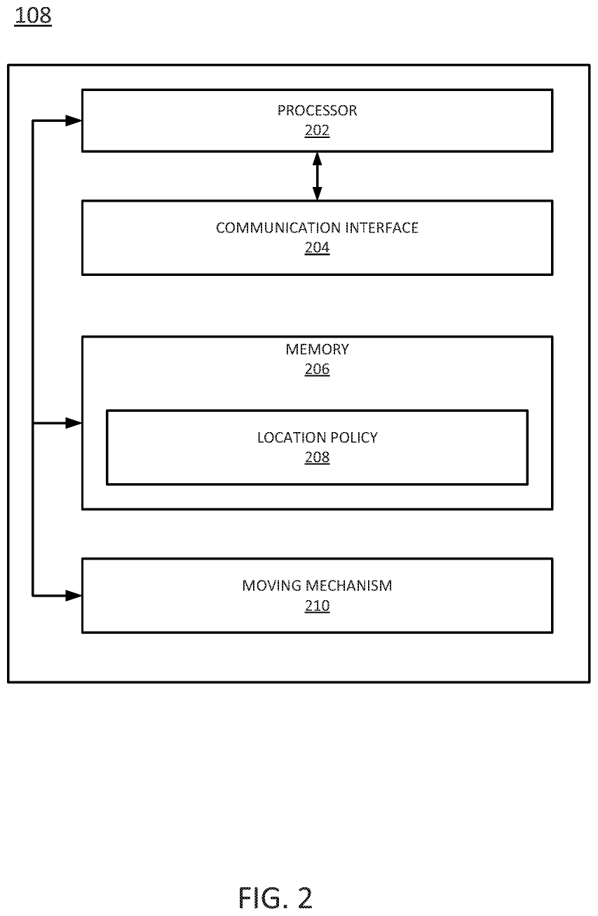

FIG. 2 illustrates a block diagram of the robot 108. It should be noted that block diagram of the robot 108 has been simplified for ease of explanation. The robot 108 may include additional components that are not shown. For example, the robot 108 may include a display to show a video image of the caller 112, a microphone to capture audio, a video camera to capture a video image of the recipient 114, a battery or power supply, interfaces to connect to a recharging station, sensors, navigational components, and the like.

In one example, the robot 108 may include a processor 202, a communication interface 204, a memory 206, and a moving mechanism 210. The processor 202 may be communicatively coupled to the communication interface 204, the memory 206, and the moving mechanism 210. The processor 202 may execute instructions to perform various operations as discussed herein. The processor 202 may also control operation of the communication interface 204 and the moving mechanism 210.

In one example, the communication interface 204 may be a wireless communication interface. The communication interface 204 may receive or transmit wireless communication signals to receive a request from the endpoint device 110 to initiate a telepresence session, to send a notification to an endpoint device of the recipient 114, communicate with other robots 108 (as discussed in further detail below), and the like.

In one example, the moving mechanism 210 may include any type of mechanism to allow the robot 108 to move from one location to another. As used herein, the term “moving mechanism” refers to a rotating assembly or physical structure with movable joints that can transport the robot 108 on the ground or through the air. For example, the moving mechanism 210 may be motorized wheels, walking legs, rotating blades that provide air movement, and the like. The robot 108 may include additional limbs such as an arm, hands, fingers, a movable torso, and the like.

In one example, the memory 206 may be a non-transitory computer readable medium. The memory 206 may be a hard disk drive, a read only memory (ROM), a random access memory (RAM), and the like. The memory 206 may store a location policy 208.

In one example, the location policy 208 may be defined by the recipient 114 or a corporate entity. The location policy 208 may define guidelines to select a location or possibly locations where the telepresence session should be initiated. The selected telepresence location may be an optimal location based on the guidelines defined by the location policy 208.

For example, the recipient 114 may define a preferred location to initiate the telepresence session (e.g., at a front door of a home of the recipient 114, an office within the home, a particular conference room in a corporate environment or building, and the like). In another example, the corporate entity may define a particular conference room where telepresence sessions should be initiated for all employees.

In one example, the location policy 208 may also include locations where the robot 108 may be prohibited or restricted. For example, the recipient 114 may set a bathroom or a bedroom as a prohibited location in the home of the recipient 114. The corporate entity may define a CEO board room, a research and development lab, a human resources department, and the like, as prohibited or restricted locations.

In one example, the location policy 208 may be defined based on different recipients. For example, in a corporate environment, some recipients may not have access or clearance to enter certain locations, while other higher level recipients may access certain locations. Thus, some locations may be restricted to some recipients, while being permissible for other higher level recipients.

In one example, the processor 202 may determine the location of the recipient 114 before the telepresence session is initiated. The location of the recipient 114 may be compared to the location policy 208 to determine if the location is an allowed location or is in a restricted location. If the location is an allowed location, the location of the recipient 114 may be a selected telepresence location. If the location is in a restricted location, the robot 108 may suggest a location nearby the recipient 114 that is allowed or not restricted under the location policy 208. The suggested location may provide the selected telepresence location to initiate the telepresence session.

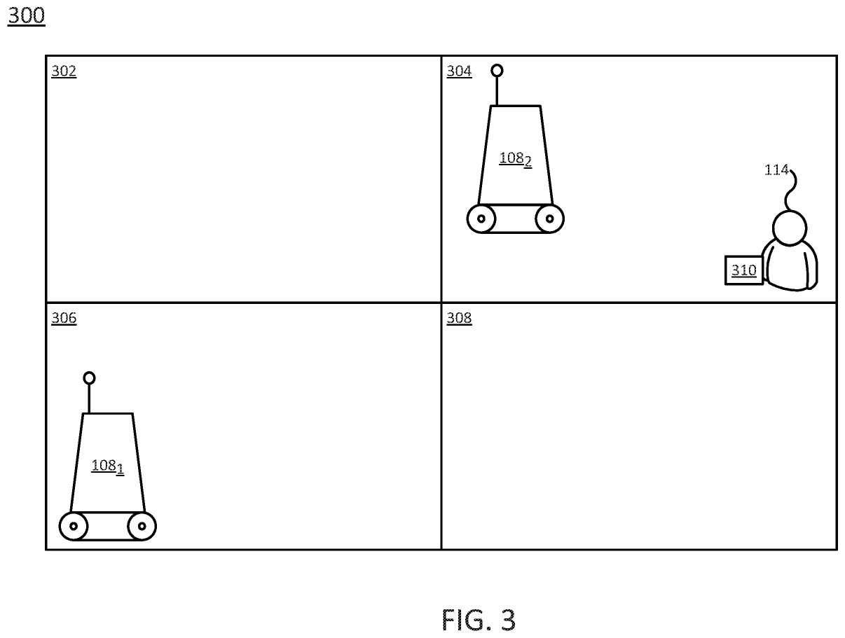

FIG. 3 illustrates example operations of a robot 108₁ and 108₂ in an environment 300. The environment 300 may be a corporate office building or a home. The environment 300 may include locations 302, 304, 306, and 308. The locations 302, 304, 306, and 308 may be different rooms or locations within the environment 300.

In one example, the environment 300 may include more than one robot 108. For example, the environment 300 may include robots 108₁ and 108₂. In one example, the robots 108₁ and 108₂ may each have a zone of operation. For example, the robot 108₁ may have a zone of operation that includes locations 302 and 306. In one example, the robot 108₂ may have a zone of operation that includes locations 304 and 308.

In one operational example, the robot 108₂ may receive a request to initiate a telepresence session (e.g., from the caller 112 using the endpoint device 110). Before the telepresence session is initiated, the robot 108₂ may determine a location of the recipient 114.

In one example, the location of the recipient 114 may be determined via location information transmitted or sent by a mobile endpoint device 310 of the recipient 114. The mobile endpoint device 310 may be a mobile phone, a smart watch, a laptop computer, and the like. The mobile endpoint device 310 may be pre-registered with the robot 108₂. As a result, the robot 108₂ may be able to ping the mobile endpoint device 310 for the location of the mobile endpoint device 310. In one example, the robot 108₂ may send a notification to the mobile endpoint device 310 and the mobile endpoint device 310 may respond with a location (e.g., global positioning system (GPS) coordinates or location information, a conference room number, and the like).

In another example, the robot 108₂ may access external applications to locate the recipient 114. For example, the recipient 114 may have a calendar stored in the mobile endpoint device 310 or on a company server (e.g., the AS 104 may be a company server within a company network). The robot 108₂ may access the calendar application to determine if the recipient 114 has an appointment at a particular location provided by the calendar application.

In the example, illustrated in FIG. 3, the recipient may be in the location 304. The robot 108₂ may then compare the location 304 of the recipient 114 to the location policy 208. If the location 304 of the recipient 114 is not a restricted location, the location 304 of the recipient 114 may be determined to be a selected telepresence location. The robot 108₂ may then move to the location 304 and initiate the telepresence session.

In another example, the location 304 may be determined to be a restricted location based on the location policy 208. As a result, the robot 108₂ may notify the recipient 114 that the location 304 is a restricted location and cannot initiate the telepresence session at the location 304. The robot 108₂ may identify the location 308 as a selected telepresence location based on the location policy 208. The robot 108₂ may send a notification to the mobile endpoint device 310 of the recipient 114 to move to the location 308 to initiate the telepresence session.

As noted above, the location policy 208 may define an optimal or desired location to initiate the telepresence session. Thus, in one example, the robot 108₂ may not need the location of the recipient 114. For example, the robot 108₂ may access the location policy 208 to determine the selected telepresence location as defined by the desired location defined by the recipient 114. The robot 108₂ may notify the recipient 114 that a telepresence session is being requested and indicate that the robot 108₂ may meet the recipient 114 at the desired location (e.g., the location 308).

In one example, the location policy 208 may include both restricted locations and desired locations. The robot 108₂ may determine the desired location defined by the recipient 114. The desired location may be compared to the restricted locations. As long as the desired location does not conflict with one of the restricted locations, the robot 108₂ may move the desired location.

In one example, the robot 108₂ may be allowed to travel through a restricted location in the location policy 208 to reach the selected telepresence location. The restricted location may define locations where the robot 108₂ may not initiate the telepresence session. For example, a restricted location may be located between the location 304 and the location 308 that is determined to be the selected telepresence location. The robot 108₂ may travel through the restricted location to arrive at the location 308.

In another operational example, the robot 108₁ may receive the request to initiate the telepresence session. The robot 108₁ may have a zone of operation that includes locations 302 and 306 as noted above. However, the location policy 208 may indicate that the recipient 114 prefers to receive the call at the location 308 or the location policy 208 may indicate that the locations 302 and 306 are restricted locations for the recipient 114.

In one example, the selected telepresence location for the recipient 114 as defined by the location policy 208 may be the location 308. As a result, the robot 108₁ may determine a robot that has a zone of operation that includes the location 308. The robot 108₁ may determine that the robot 108₂ is available and has a zone of operation that includes the location 308. The robot 108₁ may forward the request to initiate the communication session to the robot 108₂. The robot 108₂ may then notify the mobile endpoint device 310 of the recipient of the incoming request to initiate the telepresence session. The robot 108₂ may meet the recipient 114 at the location 308 to initiate the telepresence session.

In one example, the selected telepresence location may be an area within the location 308 of the recipient 114. For example, the location 308 may be a kitchen or a laboratory. The selected telepresence location may be an area within the location 308 of the recipient 114 that may prevent the robot 108₂ from interfering with equipment in the location 308 or obstruct work being performed by other individuals in the location 308.

In one example, the notification may include identification information of the robot 108₂. For example, the environment 300 may be a corporate environment with a plurality of robots that can provide telepresence sessions to multiple different recipients. As result, the recipient 114 may not know which robot will be providing the telepresence session. The notification may include a robot identification number, a robot description, a landmark (e.g., near the vending machine, near the copy machine, in the conference room, etc.) such that the recipient 114 may know which robot to look for at the location 308.

In one example, the robot 108 (e.g., the robot 108₁ or 108₂) may send a notification to the mobile endpoint device 310 when the robot 108 arrives at the selected telepresence location. The notification may provide the recipient 114 with an opportunity to delay the call. For example, the recipient 114 may be busy in a meeting or taking a shower at home. The recipient 114 may respond to the notification to have the caller 112 call back at a later time. The robot 108 may then relay the message back to the caller 112.

Although one example illustrates the location policy 208 being stored in the memory 206 of the robot 108, it should be noted that the location policy 208 may be stored in a central location. For example, a single location policy for all recipients in a corporate environment may be stored in a central server (e.g., the AS 104 of the communication network 102). Thus, when multiple robots 108 are deployed at the location 300, the robots 108 may access the centrally stored location policy 208 to determine the selected telepresence location.

Thus, the present disclosure allows the robot 108 to verify that the telepresence session is initiated in a selected telepresence location based on the location policy 208. Performing the location check before the telepresence session is initiated may prevent the robot 108 activating the telepresence session in a restricted area, in front of unintended users having a sensitive conversation, and the like.

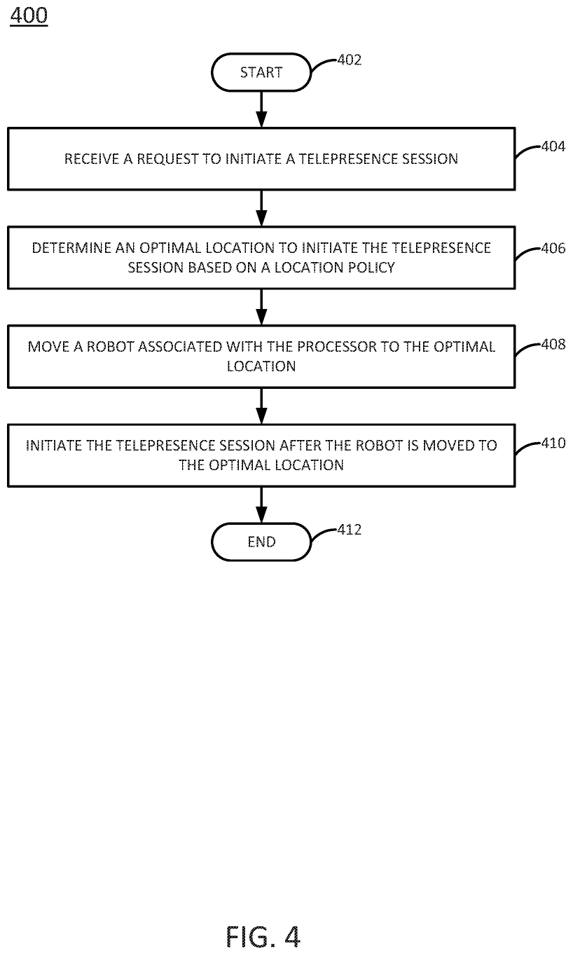

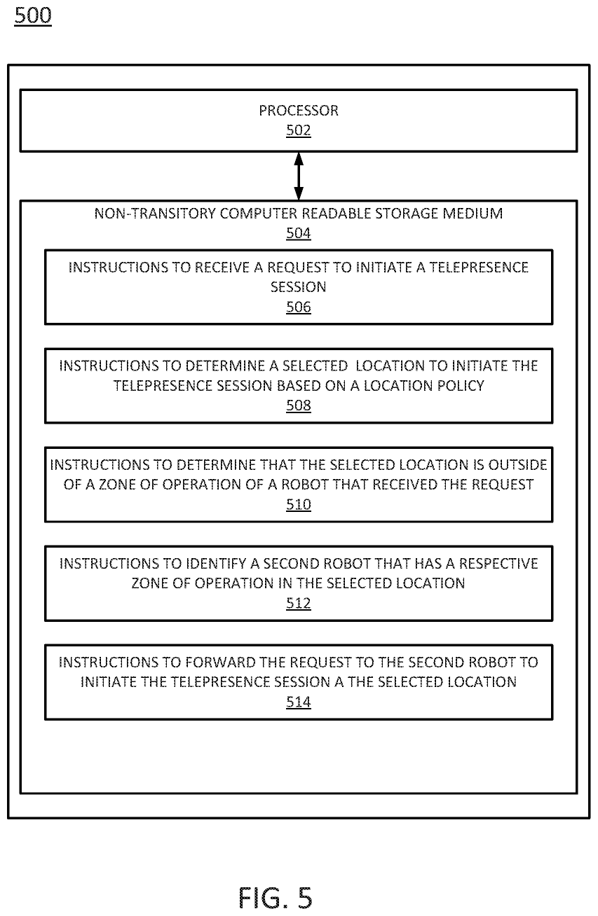

FIG. 4 illustrates a flow diagram of an example method 400 for initiating a telepresence session. In an example, the method 400 may be performed by the robot 102, or the apparatus 500 illustrated in FIG. 5, and described below.

At block 402, the method 400 begins. At block 404, the method 400 receives a request to initiate a telepresence session. In one example, the telepresence session may be initiated by a caller on an endpoint device. The request may be forwarded to a robot at a location of a recipient of the request. As noted above, the robot may be able to move to a different location. The robot may also include a display to show the caller and a video camera to capture video images of the recipient that can be transmitted back to the caller.

At block 406, the method 400 determines a selected telepresence location to initiate the telepresence session based on a location policy. In one example, the selected telepresence location may be a location defined by the recipient that is stored in the location policy. In one example, the selected telepresence location may be any location that is not a restricted or prohibited location defined by the location policy.

In one example, the selected telepresence location may be based on a comparison of the location of the recipient compared to the location policy. For example, the location of the recipient may be determined based on a GPS coordinate of a mobile endpoint device of the user, access to an external application (e.g., a calendar application), and the like. The location of the recipient may be compared to the location policy. If the location of the recipient matches a selected telepresence location defined by the location policy, then the recipient may be determined to be at the selected telepresence location. In one example, if the location of the recipient does not match the selected telepresence location defined by the location policy, the robot may suggest that the recipient to move to a selected telepresence location defined by the location policy.

In one example, the selected telepresence location may be determined dynamically based on the location policy and a dynamic context. For example, the location policy may include a list of preferred locations of the user. A preferred location from the list may be selected as the selected telepresence location based on the location of the user. In another example, the user may be moving. A predicted path of the user may be calculated and the preferred location from the list may be selected as the selected telepresence location based on the predicted path of the user. The selected location from the list may be updated as the selected telepresence location as the user continues to move along the predicted path.

At block 408, the method 400 moves a robot associated with the processor to the selected telepresence location. After the selected telepresence location is determined, the robot may move to the selected telepresence location. In one example, the location policy may also define a posture and pose of the robot. Thus, the robot may be positioned as desired by the recipient when the telepresence session is initiated.

In one example, after the robot has moved to the selected telepresence location, the robot may transmit a notification to the recipient (e.g., to the mobile endpoint device of the recipient). The notification may include identification information of the robot if one of a plurality of different robots is sent to the selected telepresence location. In one example, the notification may provide the recipient an opportunity to request the caller to call back at another time. For example, the recipient may be busy or unpresentable for a telepresence session.

At block 410, the method 400 initiates the telepresence session after the robot is moved to the selected telepresence location. After the selected telepresence location is determined and the robot is moved to the selected telepresence location the telepresence session may be initiated. For example, the telepresence session may allow the robot to mimic movements of the caller as if the caller were actually at the same location as the recipient. At block 412, the method 400 ends.

FIG. 5 illustrates an example of an apparatus 500. In an example, the apparatus 500 may be the robot 102 or the AS 104. In an example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions.

In an example, the instructions 506 may include instructions to receive a request to initiate a telepresence session. The instructions 508 may include instructions to determine a selected telepresence location to initiate the telepresence session based on a location policy. The instructions 510 may include instructions to determine that the selected telepresence location is outside a zone of operation of a robot that received the request. For example, each robot may operate within a pre-defined zone of operation. If the selected telepresence location is outside of the zone of operation, the robot may be unable to move to the selected telepresence location.

The instructions 512 may include instructions to identify a second robot that has a respective zone of operation in the selected telepresence location. For example, the environment may have a plurality of different robots deployed. Each robot or subsets of the robots may operate in different zones of operation. In one example, the robot may identify the robot that has a zone of operation in the selected telepresence location. In another example, the robot may forward the request and the determined selected telepresence location to a central server that controls operation of all of the robots. The central server may then identify the robot that has a zone of operation in the selected telepresence location.

The instructions 514 may include instructions to forward the request to the second robot to initiate the telepresence session at the selected telepresence location. As noted above, a notification may be sent to a mobile endpoint device of the recipient to identify the robot that may meet the recipient at the selected telepresence location.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a communication interface to receive a request to initiate a telepresence session;
a memory to store a location policy;
a moving mechanism to move the apparatus to a selected telepresence location to initiate the telepresence session based on the location policy; and
a processor communicatively coupled to the communication interface, the memory, and the moving mechanism, wherein the processor is to determine the selected telepresence location to initiate the telepresence session in response to the request before the telepresence session is initiated.

2. The apparatus of claim 1, wherein the communication interface is to transmit a notification to a mobile endpoint device of a recipient of the telepresence session.

3. The apparatus of claim 2, wherein the communication interface is to receive a location of the recipient in response to the notification.

4. The apparatus of claim 3, wherein the selected telepresence location is determined based on the location of the recipient.

5. The apparatus of claim 1, further comprising:
a video camera to capture an a video image of a recipient; and
a display to show a video image of a caller.

6. The apparatus of claim 1, wherein the location policy is defined by a corporate entity or a user.

7. The apparatus of claim 6, wherein the location policy defines restricted locations within a corporate environment defined by the corporate entity.

8. The apparatus of claim 6, wherein the location policy defines a desired location to initiate the telepresence session defined by the user.

9. A method comprising:
receiving, by a processor, a request to initiate a telepresence session;
determining, by the processor, a selected telepresence location to initiate the telepresence session based on a location policy;
moving, by the processor, a robot associated with the processor to the selected telepresence location; and
initiating, by the processor, the telepresence session after the robot is moved to the selected telepresence location.

10. The method of claim 9, wherein the determining, comprises:
determining, by the processor, a location of a recipient of the telepresence session; and
determining, by the processor, that the location of the recipient matches the selected telepresence location defined by the location policy.

11. The method of claim 10, wherein the determining the location of the recipient, comprises:
receiving, by the processor, a global positioning system (GPS) coordinate of a mobile endpoint device of the recipient.

12. The method of claim 10, wherein the determining the location of the recipient, comprises:
accessing, by the processor, a calendar information of the recipient to determine a location associated with a meeting in the calendar information.

13. The method of claim 9, further comprising:
transmitting, by the processor, a notification to a mobile endpoint device of a recipient of the telepresence session that the robot is at the selected telepresence location and ready to initiate the telepresence session after the robot is moved.

14. A non-transitory computer readable storage medium encoded with instructions executable by a processor, the non-transitory computer-readable storage medium comprising:
instructions to receive a request to initiate a telepresence session;
instructions to determine a selected telepresence location to initiate the telepresence session based on a location policy;
instructions to determine that the selected telepresence location is outside a zone of operation of a robot that received the request;
instructions to identify a second robot that has a respective zone of operation in the selected telepresence location;
instructions to forward the request to the second robot to initiate the telepresence session at the selected telepresence location.

15. The non-transitory computer readable storage medium of claim 14, further comprising:
instructions to send a notification to a recipient that includes identification information associated with the second robot at the selected telepresence location.
